(19) United States
(12) Patent Application Publication
(10) Pub. No.: US 2019/0382256 A1
(43) Pub. Date: Dec. 19, 2019

(54) HORSE SADDLE PAD SAFETY STRAP AND METHOD

(71) Applicants: Margaret L. HOUSE, Coronado, CA (US); Carly E. ENGEL, El Cajon, CA (US)

(72) Inventors: Margaret L. HOUSE, Coronado, CA (US); Carly E. ENGEL, El Cajon, CA (US)

(21) Appl. No.: 16/440,316

(22) Filed: Jun. 13, 2019

Related U.S. Application Data
(60) Provisional application No. 62/685,828, filed on Jun. 15, 2018.

(51) Int. Cl. B68C 1/14; B68C 1/12

(52) U.S. Cl. CPC B68C 1/147; B68C 1/12

(57) ABSTRACT

Saddle pad attachment straps and methods for securing a saddle to the saddle pad on a horse.

### CROSS-REFERENCE TO RELATED APPLICATIONS

This application claims priority to U.S. Provisional Application No. 62/685,828, filed Jun. 15, 2018, entitled “HORSE SADDLE PAD SAFETY STRAP AND METHOD” the entirety of which is hereby incorporated herein by reference as if set forth in full.

### FIELD OF THE INVENTION

The field of the invention is equine riding equipment. More specifically, the field of the invention is a horse saddle pad safety strap and methods relating thereto.

### SUMMARY OF THE INVENTION

The inventive subject matter provides a horse saddle pad safety strap with a quick release mechanism in the instance of an emergency. When riding a horse with a saddle the rider generally places a soft pad made of some type of material on the back of the horse, a saddle is placed on the pad upon which the rider sits when they are riding the horse. The pad which is placed on the back of the horse under the saddle has a tendency to slip or move out of place unless it is attached in some fashion to the saddle. In order to stop a pad from slipping, many current saddle pads are equipped with a strip of material affixed at either end to the lower edge of the saddle pad on both sides of the horse. This forms a strap for the girth to fit through. The saddle is held in place on a horse via a girth, which is the band of material or leather which attaches to both sides of the saddle and runs around the belly of a horse to secure the saddle to the back of a horse, the girth is fed through the strap of material on either side of the pad which holds the pad in place and prevents it from slipping.

Current saddle pads have the strip of material which secures the girth being firmly attached at either end of the strip to the pad. It has been an issue that the rider's foot may become caught in the strip of material when they fall off the horse. If the rider's foot becomes caught in the strip of material the rider is then drug by the horse if the horse runs off. Since the strip of material is securely attached at either end it does not break away so that the rider's foot is not released. The present invention solves this issue as the safety strap has a breakaway feature so that if the rider's foot becomes entangled in the strap one end of the strap breaks away and the rider's foot is thus released and the rider is not drug behind the horse.

Various objects, features, aspects and advantages of the inventive subject matter will become more apparent from the following detailed description of preferred embodiments, along with the accompanying drawing figures in which like numerals represent like components.

### BRIEF DESCRIPTION OF THE FIGURES

The accompanying figures, which are incorporated in and constitute a part of the specification, illustrate embodiments of the invention and, together with the description, serve to explain the objects, advantages, and principles of the invention. In the drawings:

FIG. 1 illustrates a side view of a first embodiment of a saddle pad attachment device attached to a saddle pad which is placed on the back of a horse under a saddle with a rider seated in the saddle.

FIG. 2 illustrates a right side view of a saddle pad on the back of a horse with an attachment device which is in its unhooked position.

FIG. 3 illustrates a front view of a horse and rider where a saddle pad with an attachment device is present. In this figure the riders foot has been inserted through the attachment device to display how it disconnects in the case of an emergency.

### DETAILED DESCRIPTION OF THE INVENTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

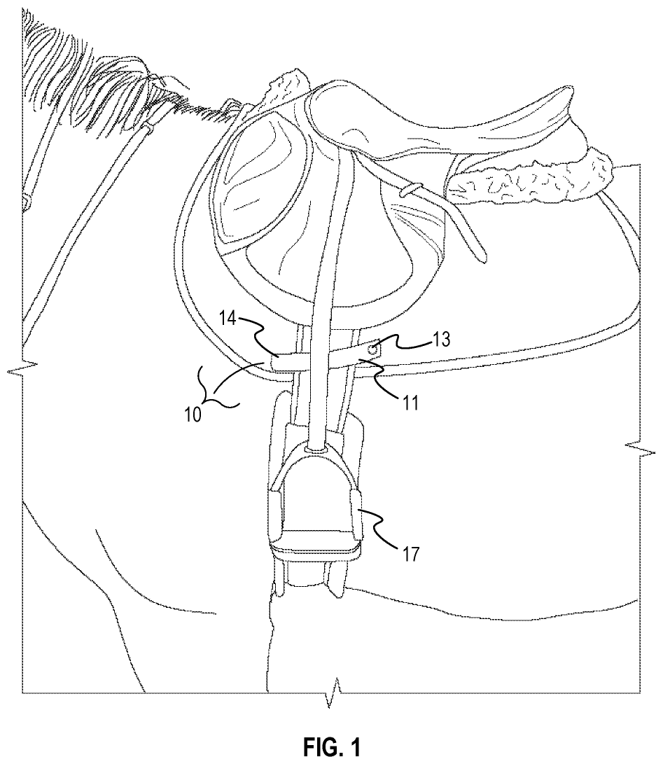

A saddle pad safety strap embodying the invention is shown and laid out in FIGS. 1-3. Referring to FIG. 1, the safety strap 10 includes a strip of material 11 which can range from 6 to 10 inches in length and ½ to 3 inches in width, and an attachment device 13. The strip of material 11 has a right end and a left end and is affixed at either end to the lower middle edge of each the right and left side of a saddle pad 12. In the present invention one end 14 of the strip of material 11 is securely affixed to the saddle pad by sewing or other means while the other end of the strip of material is attached via an attachment device 13. The attachment device 13 can be a snap, hook and loop material or other method which will easily become disconnected if pressure is placed on the strip of material 11.

The attachment device has a top 20 and a bottom 18 piece where the top piece is affixed to one end of each strip of material at one end and the bottom piece is affixed to the saddle pad. One end of each strip of material is permanently attached to the saddle pad on each the right and left side. The top attachment device 20 is affixed to one end of the strip 11 and can be secured to the bottom piece of the attachment device 18.

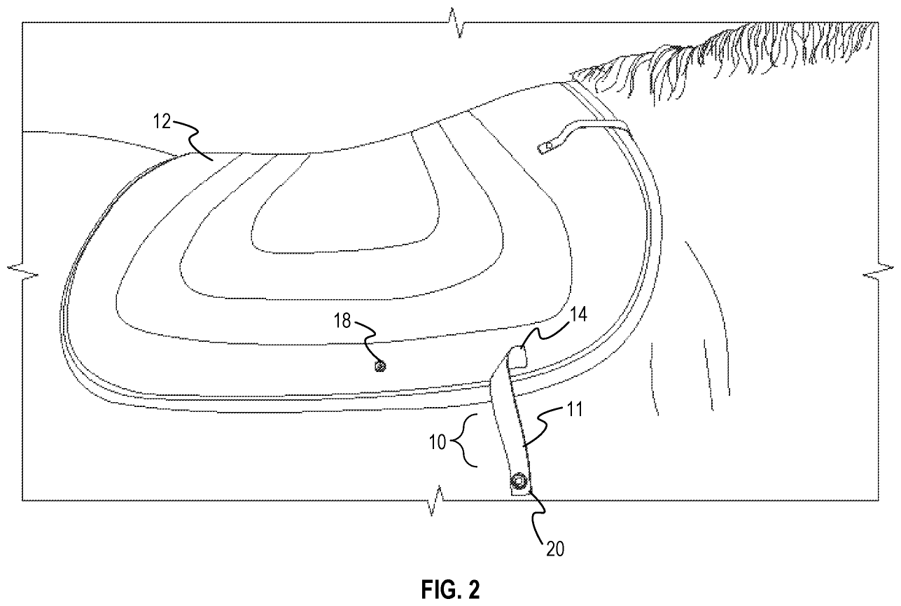

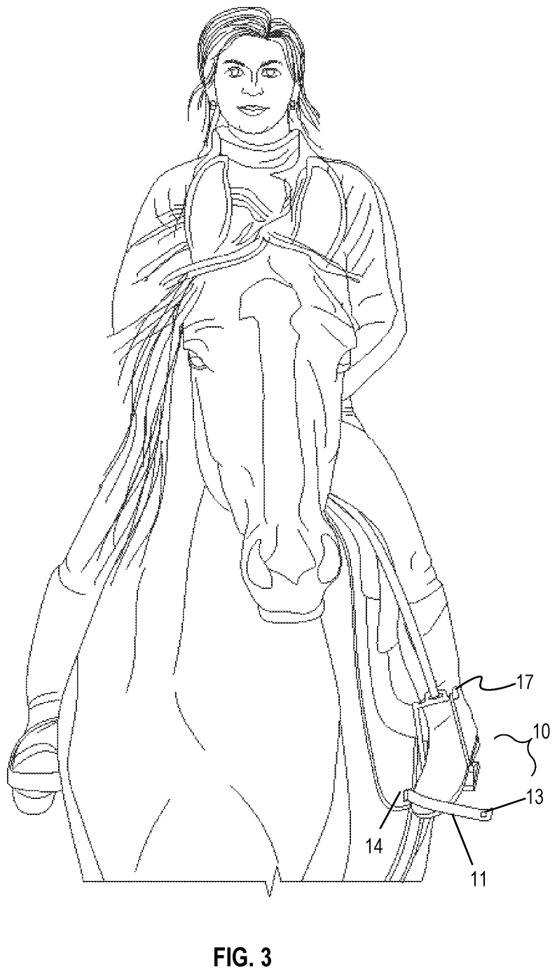

When both ends of the saddle pad safety strap 10 are attached to the saddle pad the girth 16 is fed through the strap at either side of the saddle pad 12 and the saddle 15 sits on top of the pad. The stirrups 17, which are where the rider places their feet on either side of the saddle, see FIG. 3, hang just below the safety strap 10. Referring to FIG. 2 a saddle pad safety strap 10 can been seen in its unhooked position. The attachment device 13 in FIG. 2 is a snap which has a female side 18 connected to the saddle pad 12 and the male side 19 of the snap is connected to the left side of the strip of material 11. This safety strap 10 will easily break away and become unhooked if a rider's foot becomes caught in the strap or other pressure is applied, see FIG. 3. The attachment device 13 can also be hook-and-loop material where the loop side is secured to the pad and the hook side is secured to the strap so that the strap can be attached to the pad.

Thus, specific saddle pad attachment device and related methods have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

What is claimed is:

1. A saddle pad with a safety strap, comprising:
two strips of material each having two ends;
a saddle pad with a right side and left side;
two attachment devices each with a top and bottom piece where the top piece is affixed to one end of each strip of material and the bottom piece is attached to the saddle pad on the right and left side; and
one end of each strip of material is permanently attached to the right and left side of the saddle pad.

2. The safety strap of claim 1 wherein the top attachment device affixed to the strip is secured to the bottom piece of the attachment device attached to the saddle pad.

3. The safety strap of claim 1 wherein the strap will break away if pressure is applied.

4. The safety strap of claim 1 wherein the top attachment device is a hook material and the bottom attachment device is a loop material.
